(19) United States
(12) Patent Application Publication
(10) Pub. No.: US 2015/0324423 A1
(43) Pub. Date: Nov. 12, 2015

(54) Report creation method, device and system

(71) Applicant: ZTE CORPORATION, Shenzhen, Guangdong (CN)

(72) Inventors: Chun Wang, Shenzhen (CN); Liyang Zhao, Shenzhen (CN)

(21) Appl. No.: 14/647,201

(22) PCT Filed: Oct. 28, 2013
(86) PCT No.: PCT/CN2013/086062

§ 371 Date: May 26, 2015

(30) Foreign Application Priority Data
Nov. 26, 2012 (CN) 201210485311.2

(51) Int. Cl. G06F 17/30

(52) U.S. Cl. CPC G06F 17/30412; G06F 17/30592; G06F 17/30554; G06F 17/30398

(57) ABSTRACT

A report creation method, system, and device are described, and the method includes that: abstraction processing is performed on a data table in a database, and an Abstract Data Record (ADR) model is created; a report template is created according to the ADR model, and the report template is stored; and the created report template is called, a report query operation is executed, and report data obtained by querying is displayed. Through the disclosure, a user can create a complicated report template quickly, without involving a complicated secondary development process and writing a secondary development script.

### TECHNICAL FIELD

The disclosure relates to the technical field of a report system, and particularly to a report creation method, device and system.

### BACKGROUND

An existing report system generally performs custom development in accordance with a user requirement, and when a user queries report data, only a query condition confined in a report can be input, and a result can only be displayed in accordance with an output way designed in the report. When the user requirement of querying the report data is altered, the custom development of the report is needed to be performed again, this type of report system does not support self-definition of the user. Of course, currently some report systems support the self-definition of the user, this type of report system is generally divided into two types: one type of report system can support simple self-definition, and a scope available for self-definition of the user is limited, and this type of report system can only adjust the query condition, select a query result, and select an output style; another type of report system can support complicated self-definition, the user can design a form, write a complicated query condition, and design a complicated query algorithm and a personalized output style, and the user needs to grasp a complicated secondary development process, with regard to an ordinary user, a technical threshold is high, it is difficult to be grasped, and a development cycle may also be long.

### SUMMARY

In view of this, a main purpose of an embodiment of the disclosure is to provide a report creation method, device and system, which can support creation of a complicated report template, without involving a complicated secondary development process and writing a secondary development script.

In order to achieve the above purpose, a technical scheme of the embodiment of the disclosure is implemented like this:

The embodiment of the disclosure provides a report creation method, and this method includes:

performing abstraction processing on a data table in a database, and creating an Abstract Data Record (ADR) model;

creating a report template according to the ADR model, and storing the report template; and

calling the created report template, executing a report query operation, and displaying report data obtained by querying.

Preferably, the created ADR model may include one or more ADRs, each ADR may contain two types of basic elements: a basic dimension and a basic index; the basic dimension may contain a time dimension and an object dimension; and each ADR contains a data source name;

data of one or more data tables associated with the ADR may be stored in the database corresponding to the data source name;

each basic dimension and basic index contained in the ADR separately may correspond to a specific field of one or more data tables associated with the ADR; and

one or more data tables associated with the ADR may contain a fact table and an aggregation table; and the aggregation table may be obtained by aggregating the fact table.

Preferably, the creating a report template according to the ADR model may include:

selecting one ADR associated with the report template to be created from the ADR model, and determining a position of the report template to be created on a navigation tree; and

setting a name, a query condition, output content, and a default output way of the output content of the report template to be created.

Preferably, the setting a query condition of the report template to be created may include: setting a granularity as the query condition, setting one or more granularities of the report template to be created, and making said one or more granularities to be greater than or equal to a minimum granularity supported by the ADR associated with the report template to be created; and

the setting output content of the report template to be created may include: selecting one or more from a basic dimension and a basic index contained in the ADR associated with the report template to be created as the output content.

Preferably, the method may further include:

when setting the output content of the report template to be created, extending the basic dimension contained in the ADR associated with the report template to be created to obtain a virtual dimension; and extending the basic index contained in the ADR associated with the report template to be created to obtain a Key Performance Indicator (KPI);

wherein the virtual dimension may contain a combined dimension, a self-defined dimension, a dimension group, and a sub-dimension; and the KPI may contain a common KPI, a ratio KPI, and a statistic KPI.

Preferably, the setting the output content of the report template to be created may further include: selecting one or more from the virtual dimension and the KPI as the output content, and performing parent-child relation setting on one or more dimensions which are taken as the output content; and

wherein one or more dimensions which are taken as the output content may include the basic dimension and/or the virtual dimension.

Preferably, the setting the query condition of the report template to be created may further include: taking one or more from a dimension and/or an index contained in the ADR associated with the report template to be created as the query condition; and

wherein the dimension may include the basic dimension and/or the virtual dimension; and the index may include the basic index and/or the KPI.

Preferably, the creating a report template according to the ADR model may further include: setting a time parameter, a drill option, a TOPN option, a sorting rule of the output content, and/or an extended output way of the output content of the report template to be created.

Preferably, the calling the created report template, executing a report query operation, and displaying report data obtained by querying may include: calling the created report template, generating a structured query language according to an input query condition, querying data of the data table from the database, and obtaining and displaying the report data.

Preferably, the calling the report template, generating a structured query language according to an input query condition, querying the data of the data table from the database, and obtaining and displaying the report data may include:

calling the created report template according to a user instruction, and constructing a Graphical User Interface (GUI) for a user to input a query condition;

performing authentication on an ADR associated with the called report template;

when the authentication is successful, obtaining a field object to which the user is authorized to visit, adding the field object into the input query condition to generate a new query condition;

generating the structured query language according to the new query condition, output content of the called report template, and a sorting rule of the output content;

connecting to a corresponding database according to a data source name contained in the ADR associated with the called report template, and executing the structured query language to query the data of the data table from the database to obtain the report data; and

displaying the report data according to an output way of the called report template.

Preferably, the method may further include: when setting a drill option to the created report template, performing a drill query on a record in a querying result.

The embodiment of the disclosure further provides a report creation system, which includes: a database, a report client, and a report server, wherein

the database is configured to store data of a data table, to perform abstraction processing on the data table, and to create an Abstract Data Record (ADR) model;

the report server is configured to create a report template according to the ADR model, and to store the report template; and is further configured to call the created report template, to execute a report query operation in the database, and to return report data obtained by querying to the report client; and

the report client is configured to send a report template creation instruction and a report query operation instruction to the report server; and may be further configured to display the report data obtained by the querying.

Preferably, the report server may be further configured to select one ADR associated with the report template to be created from the ADR model in the database, to determine a position of the report template to be created on a navigation tree, and to set a name, a query condition, output content, and a default output way of the output content of the report template to be created.

Preferably, the report server may be further configured to set a time parameter, a drill option, a TOPN option, a sorting rule of the output content, and/or an extended output way of the output content of the report template to be created.

Preferably, the report server may be further configured to generate a structured query language according to an input query condition, and to query the data of the data table from the database to obtain the report data.

Preferably, the report client may be further configured to call the created report template according to a user instruction, to construct a Graphical User Interface (GUI) for a user to input a query condition, and to send the query condition input by the user to the report server; and

the report server may be further configured to perform authentication on the ADR associated with the called report template; and may be further configured to obtain a field object which the user is authorized to visit when the authentication is successful, to add the field object into the input query condition to generate a new query condition, and to generate the structured query language according to the new query condition, output content of the called report template and a sorting rule of the output content; and may be further configured to connect to a corresponding database according to a data source name contained in the ADR associated with the called report template, and to execute the structured query language to query the data of the data table from the database to obtain the report data, and to send the report data to the report client.

The embodiment of the disclosure further provides a report creation device, which may include: a template creation unit and a report query unit, wherein

the template creation unit is configured to create a report template according to an Abstract Data Record (ADR) model, and to store the report template; and the ADR model may be obtained by performing abstraction processing on a data table in a database; and

the report query unit is configured to call the created report template, and to execute a report query operation to obtain report data.

Preferably, the template creation unit may be further configured to select one ADR associated with the report template to be created from the ADR model, to determine a position of the report template to be created on a navigation tree, and to set a name, a query condition, output content, and a default output way of the output content of the report template to be created.

Preferably, the template creation unit may be further configured to set a time parameter, a drill option, a TOPN option, a sorting rule of the output content, and/or an extended output way of the output content of the report template to be created.

Preferably, the report query unit may be further configured to generate a structured query language according to an input query condition, and to query data of the data table from the database to obtain the report data.

Preferably, the report query unit may be further configured to perform authentication on an ADR associated with the called report template; and may be further configured to obtain a field object which a user is authorized to visit when the authentication is successful, to add the field object into the input query condition to generate a new query condition, and to generate the structured query language according to the new query condition, output content of the called report template and a sorting rule of the output content; and may be further configured to connect to a corresponding database according to a data source name contained in the ADR associated with the called report template, and to execute the structured query language to query the data of the data table from the corresponding database to obtain the report data.

The report creation method, device and system, provided by the disclosure, perform abstraction processing on a data table in a database, and create an ADR model; create a report template according to the ADR model, and store the report template; and call the created report template, execute a report query operation, and display a report query result. This kind of report creation based on the ADR model, can create a complicated report template, without involving a complicated secondary development process and writing a secondary development script.

### BRIEF DESCRIPTION OF THE DRAWINGS

FIG. 1 is a schematic flowchart of a report creation method provided by an embodiment of the disclosure;

FIG. 2 is a schematic structural diagram of an ADR model provided by an embodiment of the disclosure;

FIG. 3 is a schematic diagram of a report creation system provided by an embodiment of the disclosure;

FIG. 4 is a schematic flowchart of creating a report template provided by an embodiment of the disclosure;

FIG. 5 is a schematic flowchart of querying a report template provided by an embodiment of the disclosure; and

FIG. 6 is a schematic flowchart of a drill query provided by an embodiment of the disclosure.

### DETAILED DESCRIPTION

A technical scheme of the disclosure is further explained in detail below in combination with the drawings and specific embodiments.

A method adopted by an embodiment of the disclosure, primarily performs model creation on a data table in a database, describes the data table in the database through an abstract data model, this abstract database model is called an Abstract Data Record (ADR) model for short, the ADR model may be conceived as describing the data table in the database from a service perspective, and this model shall face a report user and can be understood by the report user.

After the ADR model is created, a user can create several report templates according to the ADR model. After the report template is created, the user can select the report template to perform a report data query. Primarily a query condition set in the report template is filled in, and then a structured query language is automatically constructed according to the input query condition, a query result, namely report data, is obtained by querying the data table from the database, and the queried report data is displayed according to an output way set in the report template.

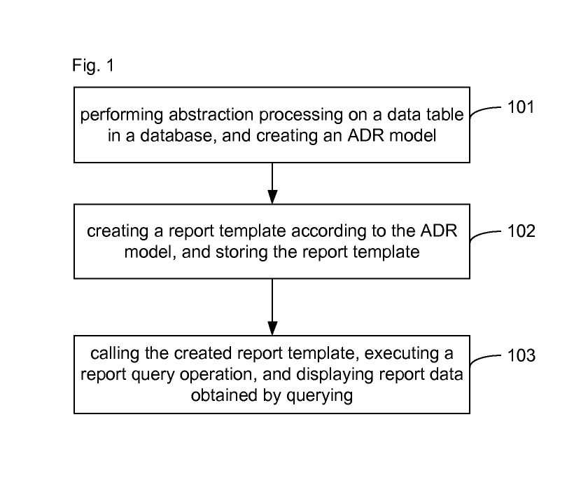

A report creation method provided by the embodiment of the disclosure, as shown in FIG. 1, includes:

Step 101: performing abstraction processing on a data table in a database, and creating an ADR model;

Step 102: creating a report template according to the ADR model, and storing the report template; and

Step 103: calling the report template, executing a report query operation, and displaying report data obtained by querying.

The above technical scheme of the embodiment of the disclosure is explained in detail below.

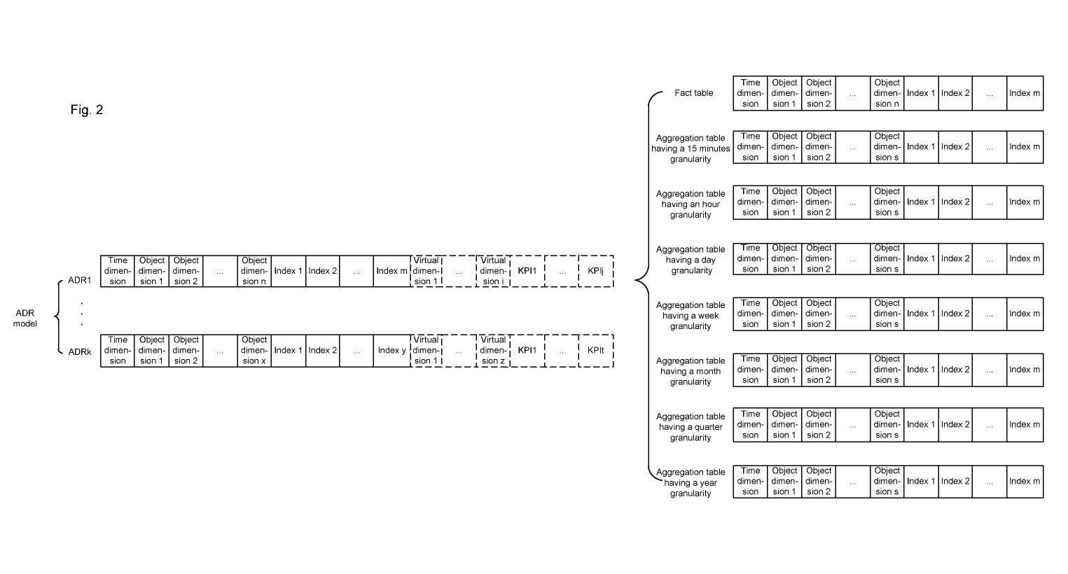

FIG. 2 is a schematic structural diagram of an ADR model.

One ADR model is composed of one or more ADRs; each ADR contains two types of basic elements: a dimension and an index (in order to easily distinguish the dimension and the index from a subsequently extended dimension and index, here the dimension and the index are called a basic dimension and a basic index separately), wherein the basic dimension may also be divided into a time dimension and an object dimension.

Preferably, in order to meet a requirement of creating a complicated report, based on two types of basic elements, namely the basic dimension and the basic index, a virtual dimension and a Key Performance Indicator (KPI) may separately extended. Then the dimension subsequently described by the embodiment of the disclosure contains the basic dimension and the virtual dimension, and the index contains the basic index and the KPI.

Wherein the virtual dimension is an extension of the dimension, and may be divided into a combined dimension, a self-defined dimension, a dimension group and a sub-dimension. The so-called combined dimension is referred to combining existing dimensions to form a new dimension, for example a Mobile Country Code (MCC) and a Mobile Network Code (MNC) may be combined as a virtual dimension Public Land Mobile Network (PLMN). The so-called self-defined dimension may implement translation of the existing dimension through some system functions, for example Internet Protocol Version 4 (IPV4(IP)), wherein the IPV4 is the system function, and represents translating an IP dimension (hexadecimal) into an IPV4 string address, or formatting the dimension by concatenating strings; for example YEAR(time)+′-′+MONTH(time), wherein YEAR is the system function, and represents extracting year information from the time dimension, and wherein MONTH is also the system function, and represents extracting month information from the time dimension, if a value of time is Sep. 8, 2012, 15:39:30, then the value corresponding to this virtual dimension above is a string “2012-09”. The so-called dimension group is referred to taking several dimensions (including the virtual dimension) as a group; when taking the dimension group as the query condition, and when executing report query, only one dimension in this dimension group can be selected as the query condition; when the dimension group is taken as output content, and when executing the report query, one dimension in this dimension group must and can only be selected as the output content. Through the dimension group, multiple report templates can be combined into one template. The so-called sub-dimension is referred to associating the dimension in the ADR with other dimension tables, for example a terminal type dimension in the ADR can be associated with a terminal manufacturer or an operation system in a terminal type dimension table, so that index analysis of the terminal manufacturer or the operation system may be implemented, and the terminal type dimension is the sub-dimension of a terminal manufacturer dimension.

The KPI is divided into a common KPI, a ratio KPI and a statistic KPI. The common KPI is referred to performing four arithmetic operations on an index of the same ADR, the four arithmetic operations of the index is a commonly used KPI, for example a success rate KPI is obtained by calculating success number/(success number+failure number). The radio KPI is used to calculate a comparison situation between a certain index of a certain dimension and the same index of other dimensions in the same type, for example a user traffic radio is a percentage of a sum of all user traffic accounted for by certain user traffic. The statistic KPI is a statistic of an amount of a certain dimension, for example a server user amount is the statistic of the user using various services.

Each ADR contains a data source name attribute, and describes a data source in which the data table associated with the ADR is stored, such as the database. Through this way, the data table may be stored in several data sources, to avoid a performance bottleneck and a capacity bottleneck caused when all data are stored in one data source. When executing the report template to query the data table, a system automatically connects the data source of the ADR corresponding to the report template, and executes the structured query language to obtain the report data.

The ADR model describes the data table in the database from the service perspective, and therefore each ADR must associate with several data tables in the database. Each basic dimension and each basic index in the ADR separately correspond to a certain specific field of the data table; no field in the data table corresponds to the virtual dimension and the KPI, but the both the virtual dimension and the KPI are obtained by performing operation and processing on the field in the data table.

The data table associated with the ADR may be divided into two types: a fact table and an aggregation table. The field of the fact table covers all the basic dimensions and the basic indexes in the ADR model, and the fact table describes a maximum amount of information. In order to improve query efficiency, a concept of the aggregation table is introduced, and the data in the aggregation table are obtained by aggregating the data in the fact table. In the same way, in order to improve the query efficiency, a corresponding aggregation table may be created separately aiming at different granularities. It can be shown in FIG. 2 that one ADR can at most associate with the aggregation table having 7 kinds of granularities (a 15 minutes granularity, an hour granularity, a day granularity, a week granularity, a month granularity, a quarter granularity, and a year granularity). Not all ADRs associate the aggregation table having so many granularities. When the user queries the report data, the system queries the aggregation table having a corresponding granularity in priority according to a report granularity, and if the aggregation table having the corresponding granularity does not exist, the system may automatically query the aggregation table having a small granularity. For example, the aggregation table associated with the ADR only has the 15 minutes granularity and the hour granularity, if the user queries a day granularity report, the system queries the data of the day granularity report from the aggregation table having the hour granularity.

Considering that a data volume in the data table is large, the data volume of each data table may be reduced in a table distribution way, so as to improve the query efficiency. Table distribution is generally performed on the fact table in accordance with a day; the table distribution is generally performed on the aggregation table having the 15 minutes granularity in accordance with the day; the table distribution is generally performed on the aggregation table having the hour granularity in accordance with a week; the table distribution is generally performed on the aggregation table having the day granularity in accordance with a month; the table distribution is generally performed on the aggregation table having the week granularity in accordance with a year; the table distribution is generally performed on the aggregation table having the month granularity in accordance with the year; the table distribution is not necessarily performed on the aggregation table having the quarter granularity and the aggregation table having the year granularity. When the system queries the report data, a corresponding data table is selected according to the queried granularity and a time scope, and if time for querying crosses multiple data tables, a union query is needed to be performed on multiple data tables.

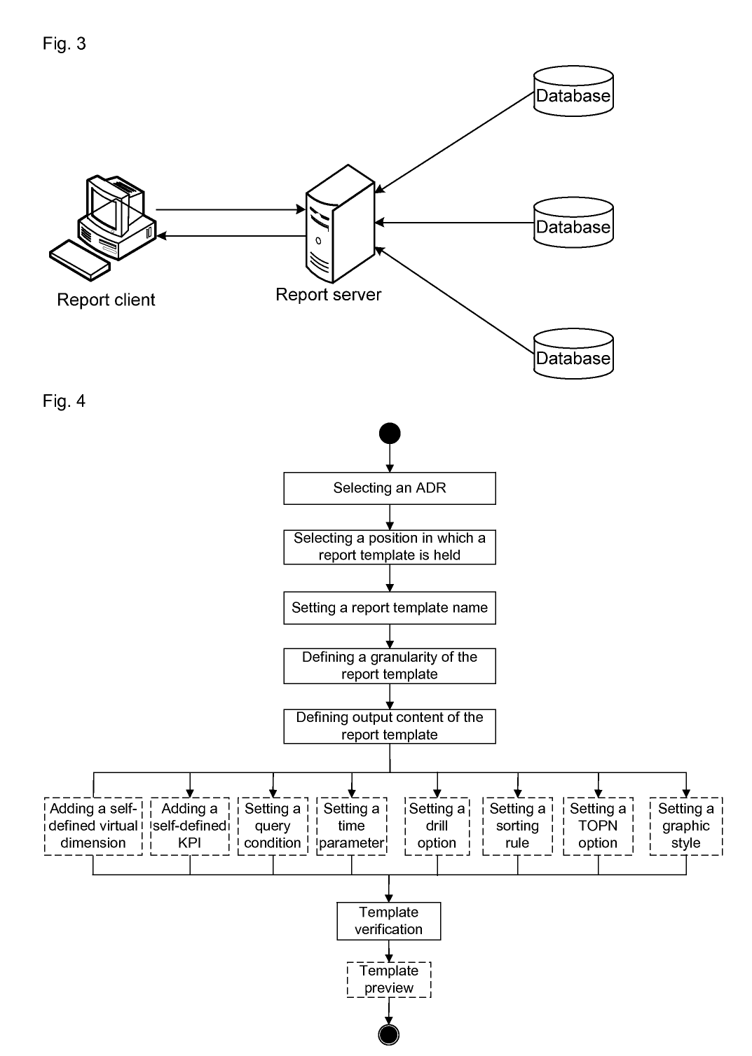

FIG. 3 is a schematic diagram of a report creation system provided by an embodiment of the disclosure, this system is composed of three parts: a report client, a report server and a database. Wherein a B/S framework is adopted between the report client and the report server, and a report client program adopts a form of a swf file, and is deposited on the report server. A flash player and a web browser are needed to be installed in the report client, and the web browser of the report client downloads the swf file from the report server, a client program is operated locally through the flash player. The report client provides three main functions, namely creating the report template (referring to a user operation), inputting a report query condition, and outputting a report query result.

The report server is in charge of creating and storing the report template according to the user operation, and executing the report query operation. During a report query process, the report server dynamically connects the database through an Open Database Connectivity (ODBC) way.

In order to support querying of massive data, the report server support access of multiple databases, the report data corresponding to different ADRs may be stored in different databases.

Specifically, when creating a report, the functions of three parts of the above system include:

the database is configured to store the data of the data table, to perform the abstraction processing on these data tables, and to create the ADR model;

the report server is configured to create the report template according to the ADR model, and to store the report template; and is further configured to call the created report template, to execute the report query operation in the database, and to return the report data obtained by querying to the report client;

the report client is configured to send a report template creation instruction and a report query operation instruction to the report server; and is further configured to display the report data obtained by the querying.

The report server is further configured to select one ADR associated with the report template to be created from the ADR model in the database, to determine a position of the report template to be created on a navigation tree, and to set a name, the query condition, output content and a default output way of the output content of the report template to be created.

The report server is further configured to set a time parameter, a drill option, a TOPN option, a sorting rule of the output content, and/or an extended output way of the output content of the report template to be created.

The report server is further configured to generate the structured query language according to the input query condition, to query the data of the data table from the database, and to obtain the report data.

The report client is further configured to call the created report template according to a user instruction, to construct a GUI for the user to input the query condition, and to send the query condition input by the user to the report server;

the report server is further configured to perform authentication on the ADR associated with the called report template; and is further configured to obtain a field object which the user is authorized to visit when the authentication is successful, to add the field object into the input query condition to generate a new query condition, and to generate the structured query language according to the new query condition, the output content of the called report template, and the sorting rule of the output content; and is further configured to connect to a corresponding database according to a data source name contained in the ADR associated with the called report template, to execute the structured query language to query and obtain the report data from the corresponding database, and to send the report data to the report client.

FIG. 4 is a process of creating a report template which is provided by an embodiment of the disclosure, and the process includes the following steps:

Step 1: selecting one ADR associated with the report template to be created from the ADR model, wherein each report template must and can only be associated with one ADR.

Step 2: selecting the position of the report template to be created on the navigation tree. Through the navigation tree, management of the created report template may be implemented.

Step 3: setting a name of the report template to be created.

Step 4: setting a granularity of the report template to be created (namely the query condition). Each ADR is configured with the granularity supported by the ADR. There may be multiple granularities configured for the report template, and all granularities of this report template must be greater than or equal to a minimum granularity supported by the ADR. (The granularity here may be set according to a requirement, such as 15 minutes, 30 minutes, 1 hour, 1 day, 1 month, 1 quarter, 1 year, and etc.)

Step 5: setting the output content of the report template to be created. One or more of the basic dimension and the basic index contained in the ADR associated with the report template to be created are selected as the output content.

Step 6: setting the default output way of the output content of the report template to be created, for example a form may be possible.

Through the above 6 steps, a simple report template may be created. If it needs to create a complicated report template, the following steps may be selected for setting.

Optional Operation 1: when setting the output content of the report template, besides the basic dimension and the basic index, one or more of the virtual dimension and the KPI may also be selected as the output content. Parent-child relation setting is performed on one or more dimensions taken as the output content.

Optional Operation 2: when setting the query condition of the report template, one or more of the dimension and/or the index contained in the ADR associated with the report template to be created may be taken as the query condition. (The dimension may include the basic dimension and the virtual dimension; the index may include the basic index and the KPI) Here, each query condition may support a common algorithm such as >, >=, <, <=, =, < >, IN, NOT IN, LL (left fuzzy matching), RL (right fuzzy matching), LIKE (fuzzy matching, which supports a wildcard such as ? and *), and etc. Multiple query conditions may be set in one report template, AND, OR, and NOR operations may be performed between these query conditions. It should be noted that when the index is taken as the query condition, an attribute of this query condition (a precondition or a post-condition) is needed to be set, and the so-called precondition is referred to performing conditional filtering on an original record; the so-called post-condition is referred to performing the conditional filtering on the query result. Whether to be preset and obliged to be selected or not may be set for each query condition. The so-called precondition is referred to the query condition which must be included each time when querying the report, and may be conceived as a specific mandatory condition. By setting the above query condition, the complicated query condition may be supported.

Optional Operation 3: the time parameter, which includes date multiple-selection, time interval selection, a busy hour, and a holiday, is set. If the date multiple-selection is set, data query of discrete dates may be implemented; if the time interval selection is set, the data query of an assigned time interval may be implemented; if the busy hour is set, the data query of the busy hour may be implemented, and the busy hour belongs to specific time interval selection; if the holiday is set, the data query of the holiday may be implemented, the holiday belongs to specific data multiple-selection.

Optional Operation 4: the drill option is set. In order to meet a data analysis requirement of the user, a drill function is needed to be provided. The so-called drill is referred to taking the query result as a condition of a next query, and a problem of positioning the user may be facilitated through this associated query. In a phase of creating the report template, only the dimension supporting the drill is needed to be selected, and a sequence of the drill may be dynamically selected during a drill query process.

Optional Operation 5: the sorting rule is set. Many report data queries need to sort the query result, and when creating the report template, a sorting field may be set. The sorting field is the dimension or the index (namely the output content), multiple sorting fields may be selected, and the sorting rule (an ascending order, a descending order) and the sequence of each sorting field may be set.

Optional Operation 6: the TOPN option is set. Multiple TOPN options may be set for one report template, each TOPN option must be assigned with a parameter: a record number (N in a TOPN), the dimension, the index, and the sorting rule. Wherein the dimension assigned by the TOPN must be taken as the output content of the report template.

Optional Operation 7: the extended output way of the output content, such as a graphic style, is set. A graphic display style adopted in the report data, such as a column chart, a stacked column chart, a tendency chart, a pie chart, an area chart, a radar chart, and a dashboard, may be set by the user. The tendency chart and the column chart support double coordinates and combination.

Through the above 7 optional operations, the user may quickly create a complicated report template, without involving a complicated secondary development process and writing a secondary development script.

After creation of the report template is finished, the report client may perform verification, to verify whether there is something omitted or a design error. After the verification of the report template is passed, the user can preview the query result of this template, and if the user is not satisfied, the report template may be partly modified or re-designed to achieve an effect what you see is what you get.

A creation function of the report template may be provided by the report client, and the designed report template is stored in the report server.

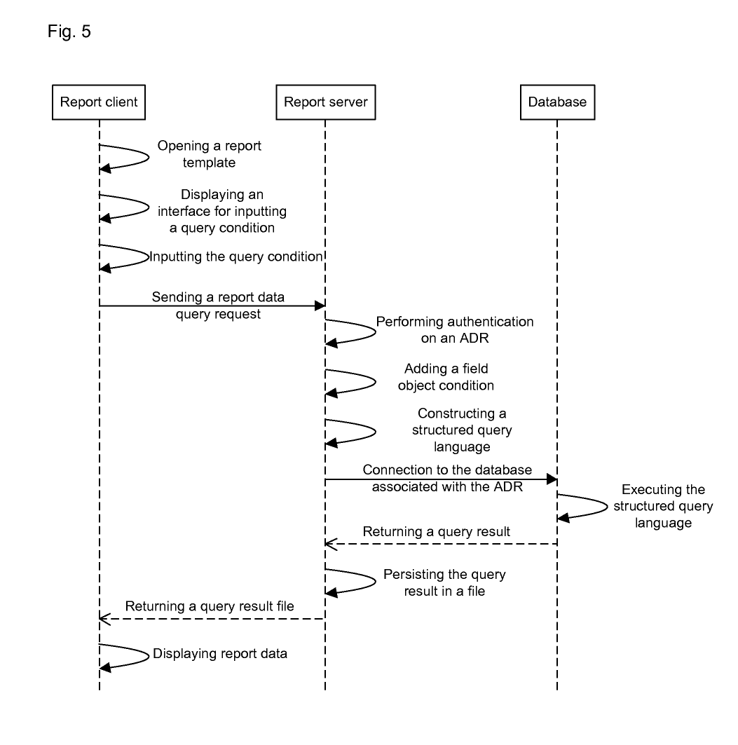

FIG. 5 is a process of querying a report template, a general procedure includes: calling the report template, generating the structured query language according to the input query condition, querying the data of the data table from the database, obtaining and displaying the report data, specifically as shown below:

1. calling the created report template according to the user instruction, and constructing the GUI for the user to input the query condition.

The user selects a certain created report template on the report client, and executes a query operation through double clicks. The report client constructs the GUI to display the query condition for selection of the user according to the query condition defined in the report template, and the precondition is not displayed in the GUI for the selection of the user. The user inputs the query condition in the GUI, and clicks the query. If the mandatory condition is not input, then an error prompt is returned; otherwise, the next step is executed.

2. The authentication is performed on the ADR visited by the user. Here, the ADR visited by the user is the ADR associated with the called report template.

The report client sends the query condition input by the user to the report server. The report server primarily perform the authentication on the ADR visited by the user, and if the authentication fails, then the error prompt is returned; otherwise, the next step is executed.

3. The field object which the user is authorized to visit is obtained and added into the input query condition, to generate a new query condition.

The report server obtains the field object which the current user can visit, and the field object is added into the query condition sent from the report client in an AND operation way, to form the new query condition. The structured query language is generated according to the new query condition, the output content of the called report template, and the sorting rule of the output content.

4. The report server connects to the corresponding database according to the data source name contained in the ADR visited by the user, and executes the structured query language to query and obtain the report data from the database.

5. The report data obtained by querying is displayed according to the output way of the called report template.

The report server makes a result of executing the structured query language, namely the report data returned after querying the database, being persisted in a local file, namely a result file, and sends the result file to the report client. The report client reads the result file returned by the report server, and performs tabular display and graphic rendering according to the output way of the report template.

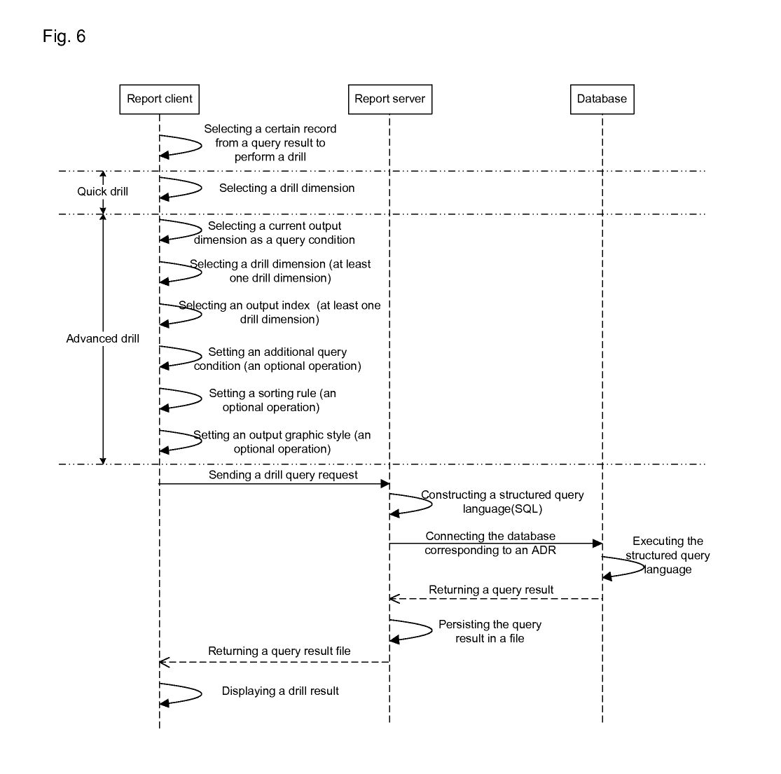

FIG. 6 is the drill query process.

If the report template is configured with the drill option, then the user may select a certain record from the query result to perform a drill query. There are two way for a drill: a quick drill and an advanced drill.

The so-called quick drill is referred to only selecting one dimension as a drill dimension each time. The current query condition and the dimension in a selected record are taken as the condition for the drill query; the drill dimension selected by the user is taken as an output dimension of the drill query; and the index of the current query is taken as an output index of the drill query.

The so-called advanced drill is referred to selecting multiple dimensions as the drill dimension each time. Certain dimensions in the output dimensions of the current query are selected as the query condition; an additional query condition may be added; the output index of the drill query may be assigned; the sorting rule of the result of the drill query may be set; an output graphic style may be set.

After the report client sends a drill query request to the report server, the report server automatically constructs an SQL according to the query condition of the drill, the output dimension, the output index and the sorting rule, and queries the data from the database. The user may perform the drill query on a drill result again. Because the output dimension of the current query (which is taken as the query condition) and a drill output dimension cannot be taken as the drill dimension, therefore each time when the drill is performed, the number of the dimensions available for the drill may be reduced, until no dimension is available for the drill, a drill process is ended.

In conclusion, adopting the method of the embodiment of the disclosure, the user may create the complicated report template. Based on this, the query of the report data and drill analysis of the data are implemented. Through a way of beforehand aggregation and database distribution and table distribution, performance bottleneck of querying massive data is solved; through authority distribution and field distribution, a security problem of the data is solved.

In order to implement the above report creation method, an embodiment of the disclosure further provides a report creation device, which includes: a template creation unit, and a report query unit, wherein

the template creation unit is configured to create a report template according to an ADR model, and to store the report template; the ADR model is obtained by performing the abstraction processing on a data table in a database;

the report query unit is configured to call the created report template, and to execute a report query operation to obtain report data.

The template creation unit is further configured to select one ADR associated with the report template to be created from the ADR model, to determine the position of the report template to be created on a navigation tree, and to set the name, a query condition, output content, and a default output way of the output content of the report template to be created.

The template creation unit is further configured to set a time parameter, a drill option, a TOPN option, a sorting rule of the output content, and/or an extended output way of the output content of the report template to be created.

The report query unit is further configured to generate the structured query language according to the input query condition, and to query data of the data table from the database to obtain the report data.

The report query unit is further configured to perform authentication on the ADR associated with the called report template; and is further configured, when the authentication is successful, to obtain a field object which the user is authorized to visit, to add the field object into the input query condition to generate a new query condition, and to generate the structured query language according to the new query condition, the output content of the called report template, and the sorting rule of the output content; and is further configured to connect to the corresponding database according to a data source name contained in the ADR associated with the called report template, and to execute the structured query language to query the data of the data table from the corresponding database, and to obtain the report data.

In addition, the above template creation unit and the report query unit may be implemented by a Central Processing Unit (CPU), a Micro Processing Unit (MPU), a Digital Signal Processor (DSP), or a Field-Programmable Gate Array (FPGA) in the report creation device.

All those described above are only preferred embodiments of the disclosure, and are not used to limit the scope of protection of the disclosure.

What is claimed is:

1. A report creation method, comprising:
performing abstraction processing on a data table in a database, and creating an Abstract Data Record (ADR) model;
creating a report template according to the ADR model, and storing the report template; and
calling the created report template, executing a report query operation, and displaying report data obtained by querying.

2. The report creation method according to claim 1, wherein the created ADR model includes one or more ADRs, each ADR contains two types of basic elements: a basic dimension and a basic index; the basic dimension contains a time dimension and an object dimension; and each ADR contains a data source name;
data of one or more data tables associated with the ADR are stored in the database corresponding to the data source name;
each basic dimension and basic index contained in the ADR separately corresponds to a specific field of one or more data tables associated with the ADR; and
one or more data tables associated with the ADR are divided into a fact table and an aggregation table; and the aggregation table is obtained by aggregating the fact table.

3. The report creation method according to claim 1, wherein the creating a report template according to the ADR model comprises:
selecting one ADR associated with the report template to be created from the ADR model, and determining a position of the report template to be created on a navigation tree; and
setting a name, a query condition, output content, and a default output way of the output content of the report template to be created.

4. The report creation method according to claim 3, wherein
the setting a query condition of the report template to be created comprises: setting a granularity as the query condition, setting one or more granularities of the report template to be created, and making said one or more granularities to be greater than or equal to a minimum granularity supported by the ADR associated with the report template to be created; and
the setting output content of the report template to be created comprises: selecting one or more from a basic dimension and a basic index contained in the ADR associated with the report template to be created as the output content.

5. The report creation method according to claim 4, further comprising:
when setting the output content of the report template to be created, extending the basic dimension contained in the ADR associated with the report template to be created to obtain a virtual dimension; and extending the basic index contained in the ADR associated with the report template to be created to obtain a Key Performance Indicator (KPI);
wherein the virtual dimension contains a combined dimension, a self-defined dimension, a dimension group, and a sub-dimension; and the KPI contains a common KPI, a ratio KPI, and a statistic KPI.

6. The report creation method according to claim 5, wherein the setting the output content of the report template to be created further comprises: selecting one or more from the virtual dimension and the KPI as the output content, and performing parent-child relation setting on one or more dimensions which are taken as the output content; and
wherein one or more dimensions which are taken as the output content comprise the basic dimension and/or the virtual dimension.

7. The report creation method according to claim 5, wherein the setting the query condition of the report template to be created further comprises: taking one or more from a dimension and/or an index contained in the ADR associated with the report template to be created as the query condition; and
wherein the dimension comprises the basic dimension and/or the virtual dimension; and the index comprises the basic index and/or the KPI.

8. The report creation method according to claim 3, wherein the creating a report template according to the ADR model further comprises: setting a time parameter, a drill option, a TOPN option, a sorting rule of the output content, and/or an extended output way of the output content of the report template to be created.

9. The report creation method according to claim 1, wherein the calling the created report template, executing a report query operation, and displaying report data obtained by querying comprise: calling the created report template, generating a structured query language according to an input query condition, querying data of the data table from the database, and obtaining and displaying the report data.

10. The report creation method according to claim 9, wherein the calling the report template, generating a structured query language according to an input query condition, querying the data of the data table from the database, and obtaining and displaying the report data comprise:
calling the created report template according to a user instruction, and constructing a Graphical User Interface (GUI) for a user to input a query condition;
performing authentication on an ADR associated with the called report template;
when the authentication is successful, obtaining a field object to which the user is authorized to visit, adding the field object into the input query condition to generate a new query condition;
generating the structured query language according to the new query condition, output content of the called report template, and a sorting rule of the output content;
connecting to a corresponding database according to a data source name contained in the ADR associated with the called report template, and executing the structured query language to query the data of the data table from the database to obtain the report data; and
displaying the report data according to an output way of the called report template.

11. The report creation method according to claim 10, further comprising: when setting a drill option to the created report template, performing a drill query on a record in a querying result.

12. A report creation system, comprising: a database, a report client, and a report server, wherein
the database is configured to store data of a data table, to perform abstraction processing on the data table, and to create an Abstract Data Record (ADR) model;
the report server is configured to create a report template according to the ADR model, and to store the report template; and is further configured to call the created report template, to execute a report query operation in the database, and to return report data obtained by querying to the report client; and
the report client is configured to send a report template creation instruction and a report query operation instruction to the report server; and is further configured to display the report data obtained by the querying.

13. The report creation system according to claim 12, wherein
the report server is further configured to select one ADR associated with the report template to be created from the ADR model in the database, to determine a position of the report template to be created on a navigation tree, and to set a name, a query condition, output content, and a default output way of the output content of the report template to be created.

14. The report creation system according to claim 13, wherein
the report server is further configured to set a time parameter, a drill option, a TOPN option, a sorting rule of the output content, and/or an extended output way of the output content of the report template to be created.

15. The report creation system according to claim 12, wherein
the report server is further configured to generate a structured query language according to an input query condition, and to query the data of the data table from the database to obtain the report data.

16. The report creation system according to claim 15, wherein
the report client is further configured to call the created report template according to a user instruction, to construct a Graphical User Interface (GUI) for a user to input a query condition, and to send the query condition input by the user to the report server; and
the report server is further configured to perform authentication on the ADR associated with the called report template; and is further configured to obtain a field object which the user is authorized to visit when the authentication is successful, to add the field object into the input query condition to generate a new query condition, and to generate the structured query language according to the new query condition, output content of the called report template and a sorting rule of the output content; and is further configured to connect to a corresponding database according to a data source name contained in the ADR associated with the called report template, and to execute the structured query language to query the data of the data table from the database to obtain the report data, and to send the report data to the report client.

17. A report creation device, comprising: a template creation unit and a report query unit, wherein
the template creation unit is configured to create a report template according to an Abstract Data Record (ADR) model, and to store the report template; and the ADR model is obtained by performing abstraction processing on a data table in a database; and
the report query unit is configured to call the created report template, and to execute a report query operation to obtain report data.

18. (canceled)

19. (canceled)

20. The report creation device according to claim 17, wherein
the report query unit is further configured to generate a structured query language according to an input query condition, and to query data of the data table from the database to obtain the report data.

21. The report creation device according to claim 20, wherein
the report query unit is further configured to perform authentication on an ADR associated with the called report template; and is further configured to obtain a field object which a user is authorized to visit when the authentication is successful, to add the field object into the input query condition to generate a new query condition, and to generate the structured query language according to the new query condition, output content of the called report template and a sorting rule of the output content; and is further configured to connect to a corresponding database according to a data source name contained in the ADR associated with the called report template, and to execute the structured query language to query the data of the data table from the corresponding database to obtain the report data.

22. The report creation device according to claim 17, wherein
the template creation unit is further configured to select one ADR associated with the report template to be created from the ADR model, to determine a position of the report template to be created on a navigation tree, and to set a name, a query condition, output content, and a default output way of the output content of the report template to be created;
the template creation unit is further configured to set a time parameter, a drill option, a TOPN option, a sorting rule of the output content, and/or an extended output way of the output content of the report template to be created.
